(19) United States
(12) Patent Application Publication
(10) Pub. No.: US 2026/0108916 A1
(43) Pub. Date: Apr. 23, 2026

(54) MECHANICAL ARTIFACT SHAKER TABLE

(71) Applicant: Ray G. Gilligan, Lexington, TX (US)

(72) Inventor: Ray G. Gilligan, Lexington, TX (US)

(21) Appl. No.: 18/919,986

(22) Filed: Oct. 18, 2024

(51) Int. Cl. B07B 1/30; B07B 1/42; B07B 1/46

(52) U.S. Cl. CPC B07B 1/30; B07B 1/42; B07B 1/4672

(57) ABSTRACT

A mechanical artifact shaker table is disclosed, including a deck having a wire mesh whereon a material is poured. One or more slidingly engage a frame to the deck. A shaft is connected to an engine, the shaft transfers movement from the engine to the deck to shake the deck, causing the separation of an artifact from the material.

### TECHNICAL FIELD

The embodiments disclosed herein generally relate to material separators and more specifically to a shaker table for mechanically separating artifacts from sediment.

### BACKGROUND

The separation of valuable artifacts from surrounding materials has long been a challenge across various industries, including archaeology, mining, and materials processing. Traditional methods often rely on manual techniques or rudimentary machinery, which can be inefficient and may lead to the loss or damage of delicate artifacts.

Existing systems for artifact separation typically involve vibrating or shaking mechanisms, but these systems often lack the precision required to protect fragile items during the separation process. Furthermore, the effectiveness of such systems can be hindered by the physical properties of the materials being processed, including their density, size, and composition.

There is a need for improved apparatuses that can efficiently and safely separate artifacts from various materials. Such apparatuses should minimize the risk of damage to artifacts while ensuring effective sedimentation of unwanted materials. Additionally, the ability to easily adjust the operational parameters of these systems could enhance their versatility in different applications.

The field of material separation continues to evolve, and ongoing innovation is necessary to address the limitations of current technologies. The development of more effective and user-friendly systems would significantly benefit industries reliant on artifact recovery and separation, providing improved operational efficiencies and safeguarding the integrity of valuable items during processing.

### SUMMARY OF THE INVENTION

This summary is provided to introduce a variety of concepts in a simplified form that is further disclosed in the detailed description of the embodiments. This summary is not intended for determining the scope of the claimed subject matter.

A mechanical artifact shaker table is disclosed, including a deck having a wire mesh whereon a material is poured. One or more slidingly engage a frame to the deck. A shaft is connected to an engine, the shaft transfers movement from the engine to the deck to shake the deck, causing the separation of an artifact from the material by causing sediment to fall through the wire mesh and the artifact to be retained on top of the wire mesh.

In one aspect, the shaft is configured having a ¾″ offset at a center position to enable the deck to oscillate 1.5″ between a forward position and a rearward position, maximizing efficiency of the shaking motion while minimizing potential damage to the artifacts.

In one aspect, a reducer is mounted to the engine and positioned around the shaft, wherein the reducer is configured having a 5:1 gear ratio. The 5:1 gear ratio provides an advantageous oscillation speed to reduce the likelihood of damaging the artifact during the separation process.

In one aspect, the engine is configured to move the shaft at a rate of between 220-280 rotations per minute. This range provides a balance between effective agitation of the material and the protection of the artifacts.

In one aspect, the wire mesh is constructed of ½″ woven wire. This construction allows for effective sedimentation while ensuring that artifacts of varying sizes are retained on the mesh surface.

In one aspect, the one or more tracks enable the gliding motion of the deck to agitate the material and to separate the artifact from the material.

In one aspect, a collection surface is positioned underneath the wire mesh, the collection surface to collect a sediment.

In one aspect, the shaker table incorporates safety features, including emergency shut-off switches and protective guards, to ensure operator safety during operation.

In one aspect, a remote-control panel is integrated, allowing operators to monitor and adjust settings.

In one aspect, the shaker table can be modular, allowing for assembly and disassembly for maintenance or transport.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates a perspective view of the mechanical artifact shaker table, according to some embodiments;

FIG. 1B illustrates a perspective view of the mechanical artifact shaker table oscillating back and forth to separate the artifacts from the material, according to some embodiments;

FIG. 2 illustrates a top plan view of the deck and wire mesh, according to some embodiments;

FIG. 3 illustrates a perspective view of the engine, reducer, and shaft, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “material” refers to the sediment combined with artifacts that are processed by the shaker table.

As used herein, the term “artifact” encompasses valuable items such as arrowheads and similar objects which are separated from the material and sediment thereof.

In general, the embodiments described herein provide a mechanical artifact shaker table which is used to separate artifacts from a raw material. The mechanical artifact shaker table includes a deck having a wire mesh surface which collects artifacts thereon, while allowing the material to fall through its openings. To facilitate this process, an engine is connected via a shaft to the deck and oscillates, through the engines mechanical motion when connected to the shaft, the deck to shake and separate the material from the artifacts.

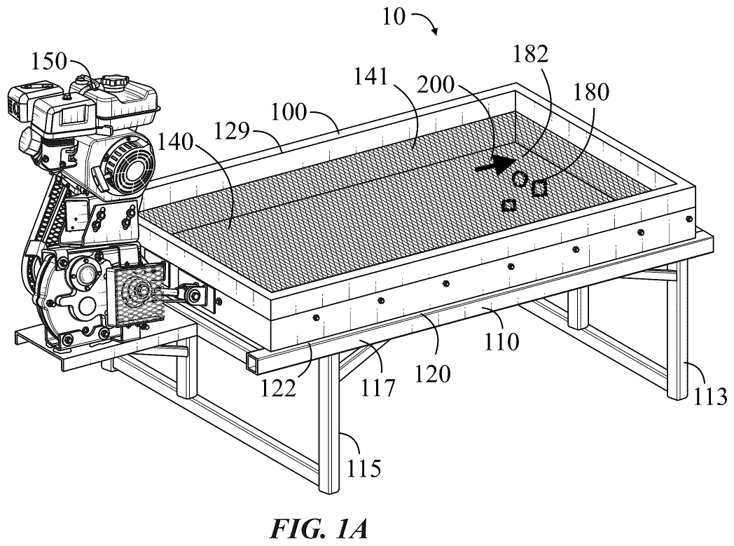

FIGS. 1A and 1B illustrate a perspective view of the mechanical artifact shaker table 10. The shaker table 10 is designed to facilitate the separation of artifacts from material 180, defined herein as sediment (e.g., dirt) mixed with valuable items. FIG. 1B illustrates the mechanical artifact shaker table oscillating back and forth to separate the artifacts from the material 180.

The deck 100 is slidingly engaged to a frame 110 via one or more tracks 120 that facilitate the gliding motion of the deck 100, thus enabling the agitation of the material 180 and the separation of artifacts. The tracks 120, which are constructed with a V-shaped groove 122, form channels that direct the linear movement of the oscillation.

In further reference to FIG. 1B, during use, the operator loads the material onto the deck 100 such as by pouring dirt over the wire mesh 140. The engine 150 then drives the shaft to cause the table to oscillate between a forward position 125 and a rearward position 127 as is represented by the arrows. A center position 129 (see FIG. 1) may be defined as the central axis along the oscillation path between the forward position 125 and the rearward position 127. The forward position may be defined as the deck 100 moving in a linear motion toward the first end 190 of the frame 110 while the rearward position 127 may be defined as the deck 100 moving in linear motion toward the second end 192 of the frame 110. Artifacts 200 are separated and remain on top 141 of the wire mesh 140 while the sediment falls through the openings of the wire mesh and is collected on a collection surface 182.

The mechanical artifact shaker table 10, as described, is designed with both functionality and user ergonomics in mind, allowing for the effective and efficient separation of valuable artifacts 200 from surrounding material 180.

In reference to FIG. 1A, the frame 110 includes a first set of legs 113 and a second set of legs 115 which are connected to a top 117 of the frame 110. In such, the top 117 of the frame 110 supports the deck 100 which is slidably connected to the frame 110 by the tracks 120.

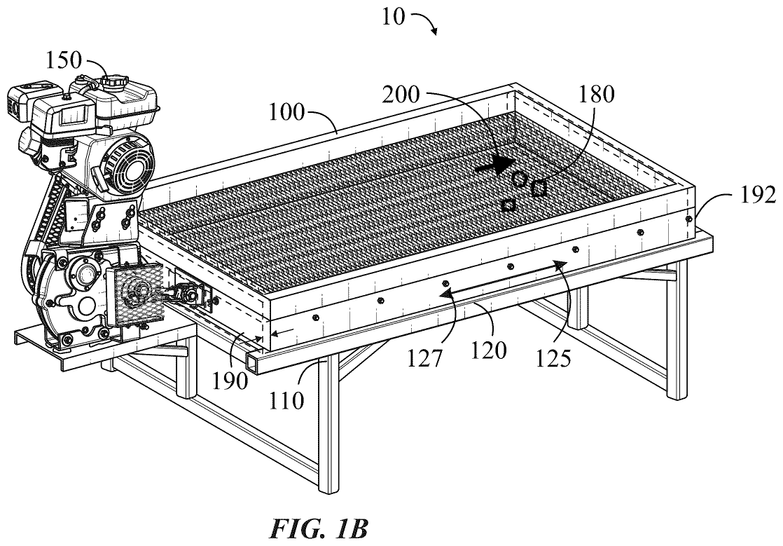

FIG. 2 illustrates the deck 100 and wire mesh 140 which is constructed to enable the material from falling through openings in the wire mesh 140 while retaining the artifact on top of the wire mesh 140. As is shown in FIGS. 1A-1B, the material 180 rests on the collection surface 182 once it has fallen through the openings of the wire mesh 140. The wire mesh 140 may be removable engaged from the deck 100 to allow the user to lift the wire mesh 140 off of the deck for cleaning and/or for the collection of artifacts. This may also enable the user to replace the wire mesh 140.

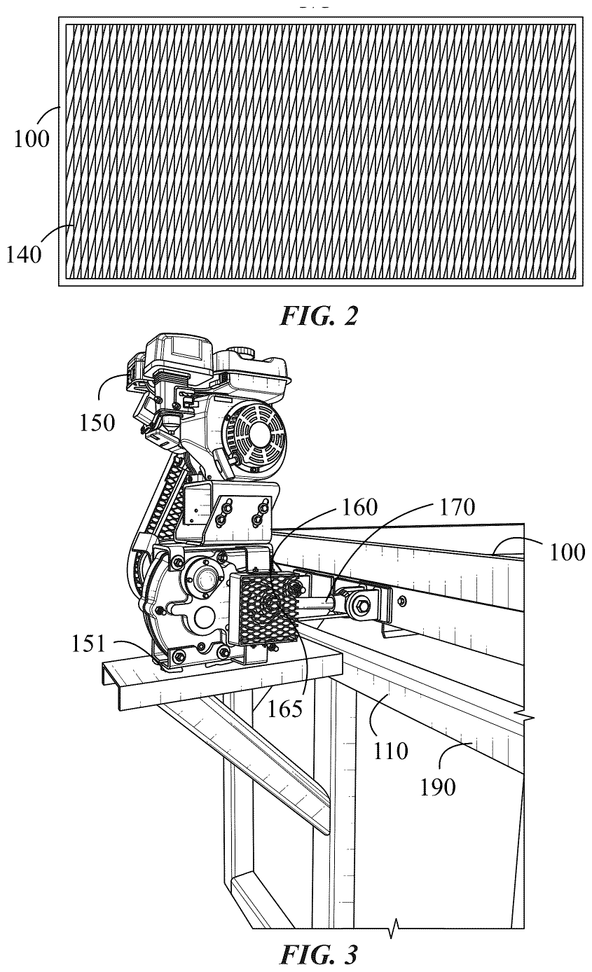

FIG. 3 illustrates a perspective view of the engine 150, reducer 160, shaft 165, and one or more rods 170. The engine 150, positioned on an engine mount 151 at the first end 190 of the frame 110, drives the shaft 165 within the reducer 160 which is connected to the rods 170. The rods 170 are connected to the deck 100 to transfer movement thereto. The rods 170 allow for the transfer of movement that causes the deck 100 to shake and facilitate the separation process. The shaft 165 is configured with a ¾″ offset at a center position, enabling the deck 100 to oscillate 1.5″ between a forward position and a rearward position. The reducer 160, connecting the shaft 165 to the engine 150, positioned by the engine mount 151, is configured with a 5:1 gear ratio. The engine 150 operates at a rate of between 220-280 rotations per minute, delivering the necessary power for effective operation.

The wire mesh 140, constructed of ½″ woven wire, serves as a filtering mechanism that retains artifacts 200 while allowing sediment to fall through, facilitating the collection of material beneath.

A collection surface 130 is positioned underneath the wire mesh 140 to gather sediment that falls through during the separation process.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A mechanical artifact shaker table comprising:
a deck including a wire mesh whereon a material is poured;
one or more tracks slidingly engaged to the deck, wherein the one or more tracks are each constructed having a V-shaped groove to form a channel directing the oscillating motion of the frame; and
a shaft connected to an engine, the shaft to transfer movement from the engine to one or more rods each connected to the deck to cause the deck to shake and separate an artifact from the material.

2. The mechanical artifact shaker table of claim 1, wherein the shaft is configured having a ¾″ offset at a center position to enable the deck to move 1.5″ between a forward position and a rearward position.

3. The mechanical artifact shaker table of claim 1, further comprising a reducer mounted to the engine and positioned around the shaft, wherein the reducer is configured having a 5:1 gear ratio.

4. The mechanical artifact shaker table of claim 1, wherein the engine is configured to move the shaft at a rate of between 220-280 rotations per minute.

5. The mechanical artifact shaker table of claim 1, wherein the wire mesh is constructed of ½″ woven wire.

6. The mechanical artifact shaker table of claim 1, wherein the one or more tracks enable an oscillating motion of the deck to agitate the material and to separate the artifact from the material.

7. The mechanical artifact shaker table of claim 1, further comprising a collection surface positioned underneath the wire mesh, the collection surface to collect a sediment.

8. A mechanical artifact shaker table comprising:
a deck positioned on a frame;
a wire mesh positioned on the deck whereon a material is poured;
one or more tracks slidingly engaged to the deck, wherein the one or more tracks are each constructed having a V-shaped groove to form a channel directing the oscillating motion of the frame; and
a shaft connected to an engine, the shaft to transfer movement via one or more rods connected to the deck from the engine to the deck to cause the deck to oscillate between a forward position and a rearward position to separate an artifact from the material.

9. The mechanical artifact shaker table of claim 8, wherein the shaft is configured having a ¾″ offset at a center position to enable the deck to oscillate 1.5″ between the forward position and the rearward position.

10. The mechanical artifact shaker table of claim 8, further comprising a reducer mounted to the engine and positioned around the shaft, wherein the reducer is configured having a 5:1 gear ratio.

11. The mechanical artifact shaker table of claim 8, wherein the engine is configured to move the shaft at a rate of between 220-280 rotations per minute.

12. The mechanical artifact shaker table of claim 8, wherein the wire mesh is constructed of ½″ woven wire.

13. The mechanical artifact shaker table of claim 8, wherein the one or more tracks enable an oscillating motion of the deck to agitate the material and to separate the artifact from the material.

14. The mechanical artifact shaker table of claim 8, further comprising a collection surface positioned underneath the wire mesh, the collection surface to collect a sediment.

15. (canceled)

16. The mechanical artifact shaker table of claim 8, wherein the frame includes a first end and a second end, wherein the engine is positioned at the first end.

17. The mechanical artifact shaker table of claim 16, wherein the engine is fastened to an engine mount positioned on the first end.

18. The mechanical artifact shaker table of claim 17, further comprising a first set of legs and a second set of legs to raise the deck.

19. The mechanical artifact shaker table of claim 18, wherein a top connects the first set of legs to the second set of legs, and wherein the top supports the deck.

20. A mechanical artifact shaker table, comprising:
a deck slidingly engaged to a frame via one or more tracks, wherein the one or more tracks are each constructed having a V-shaped groove to form a channel directing the oscillating motion of the frame;
a wire mesh positioned on the deck whereon a material is poured;
a shaft connected to an engine via a reducer, the shaft to transfer movement from the engine to the deck to cause the deck to oscillate between a forward position and a rearward position to separate an artifact from the material; and
a collection surface positioned under the deck to collect a sediment, wherein the artifact is retained on the wire mesh.
